(19) United States
(12) Patent Application Publication
(10) Pub. No.: US 2020/0057977 A1
(43) Pub. Date: Feb. 20, 2020

(54) PARCEL DELIVERY SYSTEM AND NON-TRANSITORY COMPUTER READABLE MEDIUM

(71) Applicant: FUJI XEROX CO., LTD., Tokyo (JP)

(72) Inventors: Hideki FUJIMOTO, Kanagawa (JP); Hajime KAJIYAMA, Kanagawa (JP); Akira ICHIKAWA, Kanagawa (JP); Xiongfan JIN, Kanagawa (JP); Tetsuya KOBAYASHI, Kanagawa (JP); Mariko MIYAZAKI, Kanagawa (JP)

(73) Assignee: FUJI XEROX CO., LTD., Tokyo (JP)

(21) Appl. No.: 16/537,632

(22) Filed: Aug. 12, 2019

(30) Foreign Application Priority Data
Aug. 20, 2018 (JP) 2018-154195

(51) Int. Cl. G06Q 10/08; G06T 7/70; G06T 7/50

(52) U.S. Cl. CPC G06Q 10/083; G06T 7/50; G06T 7/70

(57) ABSTRACT

A parcel delivery system includes a receiving unit and a selecting unit. The receiving unit receives information regarding an external shape of a parcel requested to be delivered in response to a request from a client who requests delivery of the parcel. The selecting unit selects, on the basis of the information regarding the external shape of the parcel, which is received by the receiving unit, a delivery apparatus that delivers the parcel by taking into consideration empty space in the delivery apparatus.

### CROSS-REFERENCE TO RELATED APPLICATIONS

This application is based on and claims priority under 35 USC 119 from Japanese Patent Application No. 2018-154195 filed Aug. 20, 2018.

### BACKGROUND

### (i) Technical Field

The present disclosure relates to a parcel delivery system and a non-transitory computer readable medium.

### (ii) Related Art

For example, Japanese Unexamined Patent Application Publication No. 2002-24627 discloses a parcel collection and delivery system that delivers a parcel to the recipient. The parcel collection and delivery system includes: displaying a homepage screen via the Internet for making an estimate of the delivery fee for a parcel; displaying, on the homepage screen, at least one of the estimated fee and the delivery schedule, which are estimated on the basis of at least the client address and the recipient address input via the Internet; and selecting, by the client, whether to request the delivery on the basis of at least one of the estimated fee and the delivery schedule.

For example, a parcel delivery system using a self-propelled delivery apparatus for delivering parcels from and to individuals in a small community or the like has been considered. This parcel delivery system has an advantage that it is unnecessary to maintain and manage parcels because parcels are not collected by a collection and delivery center, for example, and thus, the operation cost is reduced. At the same time, acceptance of parcels is restricted by the capacity of each delivery apparatus. Therefore, in some cases, when a delivery apparatus actually comes to collect a parcel, it is found at that moment that the delivery apparatus is incapable of accepting the parcel.

### SUMMARY

Aspects of non-limiting embodiments of the present disclosure relate to enhancing the probability of a delivery apparatus that is capable of accepting a parcel coming to collect a parcel, compared with the case in which information regarding the external shape of a parcel is not obtained.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a parcel delivery system including a receiving unit and a selecting unit. The receiving unit receives information regarding an external shape of a parcel requested to be delivered in response to a request from a client who requests delivery of the parcel. The selecting unit selects, on the basis of the information regarding the external shape of the parcel, which is received by the receiving unit, a delivery apparatus that delivers the parcel by taking into consideration empty space in the delivery apparatus.

### BRIEF DESCRIPTION OF THE DRAWINGS

An exemplary embodiment of the present disclosure will be described in detail based on the following figures, wherein:

FIG. 1 is a diagram illustrating an exemplary overall configuration of a parcel delivery system according to an exemplary embodiment;

FIG. 2 is a diagram illustrating an exemplary hardware configuration of a self-propelled delivery apparatus according to the present exemplary embodiment;

FIG. 3 is a diagram illustrating an exemplary hardware configuration of a delivery management server according to the present exemplary embodiment;

FIG. 4 is a block diagram illustrating an exemplary functional configuration of the parcel delivery system according to the present exemplary embodiment;

FIG. 5 is a diagram for describing an exemplary process of estimating the external size of a parcel;

FIG. 6 is a diagram for describing an exemplary process of estimating the weight of a parcel;

FIG. 7 is a diagram illustrating exemplary information on density defined for each type of contents;

FIG. 8 is a diagram illustrating an exemplary captured image of a parcel storage unit, which is captured with a parcel storage unit camera;

FIG. 9 is a diagram illustrating a display example in which the external shape of a parcel and empty space are superimposed on each other;

FIG. 10 is a flowchart illustrating an example of a series of processing steps performed by the parcel delivery system according to the present exemplary embodiment;

FIG. 11 is a flowchart illustrating an example of a procedure of estimating the external size of a parcel, performed by a parcel external shape estimating unit of a client terminal; and

FIG. 12 is a flowchart illustrating an example of a procedure of estimating the weight of a parcel, performed by a parcel weight estimating unit of the client terminal.

### DETAILED DESCRIPTION

Hereinafter, an exemplary embodiment of the present disclosure will be described in detail with reference to the attached drawings.

### Overall Configuration of System

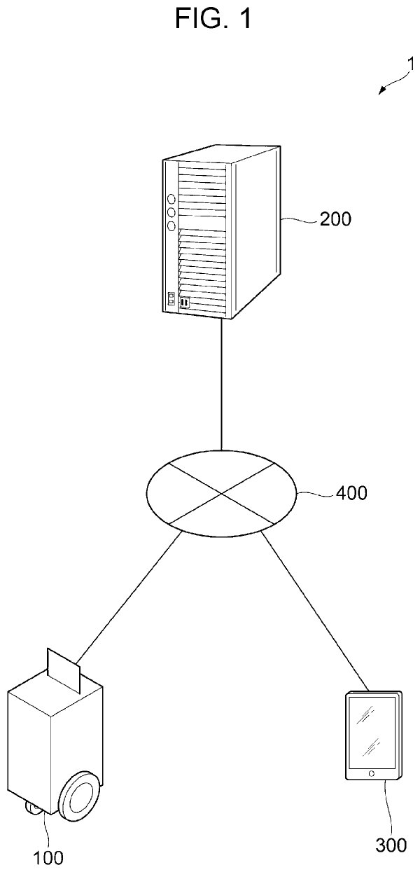

FIG. 1 is a diagram illustrating an exemplary overall configuration of a parcel delivery system 1 according to an exemplary embodiment. As illustrated in FIG. 1, the parcel delivery system 1 according to the present exemplary embodiment includes a self-propelled delivery apparatus 100, a delivery management server 200, and a client terminal 300. The self-propelled delivery apparatus 100, the delivery management server 200, and the client terminal 300 are connected to a network 400.

The self-propelled delivery apparatus 100 is a self-propelled apparatus that delivers parcels within a predetermined range such as a small community. Although one self-propelled delivery apparatus 100 is illustrated in the example illustrated in FIG. 1, the number of self-propelled delivery apparatuses 100 is not limited to one. In other words, the parcel delivery system 1 includes one or more self-propelled delivery apparatuses 100.

The delivery management server 200 is a computer apparatus that manages delivery of parcels. Examples of the delivery management server 200 include a server apparatus, a personal computer (PC), and the like. On receipt of a request from the client terminal 300 to deliver a parcel, the delivery management server 200 selects a self-propelled delivery apparatus 100 that delivers the parcel.

The client terminal 300, which is an example of a terminal apparatus, is a computer apparatus that is operated by a client who requests delivery of a parcel (hereinafter may simply be referred to as a “client”). Examples of the client terminal 300 include a mobile information terminal such as a smart phone and a cellular phone, a tablet PC, and the like. The client terminal 300 receives a request from a client to deliver a parcel, and transmits the received delivery request to the delivery management server 200. Although one client terminal 300 is illustrated the example illustrated in FIG. 1, the number of client terminals 300 is not limited to one. In other words, one or more clients may operate his/her or their own client terminals 300 to request delivery in the parcel delivery system 1.

The network 400 is a communication means used for communicating information among the self-propelled delivery apparatus 100, the delivery management server 200, and the client terminal 300, and includes, for example, the Internet, public lines, and local area networks (LANs). In addition, the network 400 includes networks based on wired communication and network based on wireless communication.

### Hardware Configuration of Self-Propelled Delivery Apparatus

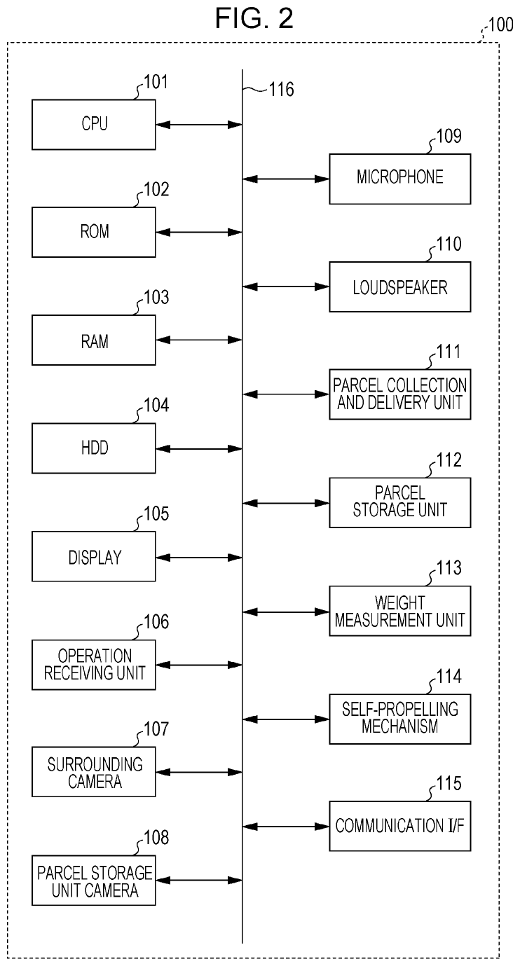

FIG. 2 is a diagram illustrating an exemplary hardware configuration of the self-propelled delivery apparatus 100 according to the present exemplary embodiment.

As illustrated in FIG. 2, the self-propelled delivery apparatus 100 according to the present exemplary embodiment includes a central processing unit (CPU) 101, which controls the overall apparatus through execution of programs (including firmware), read-only memory (ROM) 102, which stores programs such as basic input output system (BIOS) and firmware, and random-access memory (RAM) 103, which is used as a program execution area.

In addition, the self-propelled delivery apparatus 100 includes a hard disk drive (HDD) 104, which is a storage area that stores various programs such as the operating system (OS) and applications, data input to the various programs, and data output from the various programs.

Furthermore, the self-propelled delivery apparatus 100 includes a display 105, which displays a user interface screen and the like; an operation receiving unit 106, which receives an operation performed by a client on a touchscreen or the like; a surrounding camera 107, which takes a picture of the surroundings of the self-propelled delivery apparatus 100; a parcel storage unit camera 108, which takes a picture of a later-described parcel storage unit 112; a microphone 109, which detects external sound; and a loudspeaker 110, which outputs sound to the outside. In the present exemplary embodiment, the parcel storage unit camera 108 is used as an example of an image capturing unit installed in a delivery apparatus.

In addition, the self-propelled delivery apparatus 100 includes a parcel collection and delivery unit 111, which collects a parcel from the client and delivers the parcel to the recipient; the parcel storage unit 112, which accommodates the parcel collected from the client; and a weight measurement unit 113, which measures the weight of the parcel accommodated in the parcel storage unit 112. In the present exemplary embodiment, the weight measurement unit 113 is used as an example of a weight measurement unit.

Furthermore, the self-propelled delivery apparatus 100 includes a self-propelling mechanism 114, which drives wheels (not illustrated) to enable free running. The self-propelling mechanism 114 in the present exemplary embodiment includes a motor that drives the wheels, and a steering mechanism that controls the direction of the wheels. The self-propelled delivery apparatus 100 moves forward or backward due to the rotation of the wheels. The direction in which the self-propelled delivery apparatus 100 moves is switched in accordance with the direction of the wheels.

In addition, the self-propelled delivery apparatus 100 includes a communication interface (I/F) 115, which is used for communicating with the outside.

The above-described units are connected to one another through a bus 116 and exchange data through the bus 116.

### Hardware Configuration of Delivery Management Server

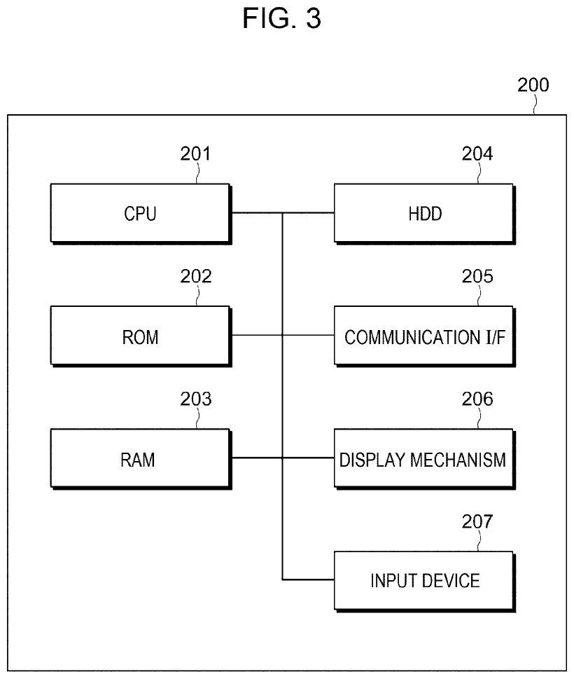

FIG. 3 is a diagram illustrating an exemplary hardware configuration of the delivery management server 200 according to the present exemplary embodiment.

As illustrated in FIG. 3, the delivery management server 200 according to the present exemplary embodiment includes a CPU 201, which is an arithmetic operation unit; ROM 202, which is a storage area that stores programs such as BIOS; and RAM 203, which is a program execution area. In addition, the delivery management server 200 includes an HDD 204, which is a storage area that stores various programs such as OS and applications, data input to the various programs, and data output from the various programs. The CPU 201 loads various programs stored in, for example, the HDD 204 to the RAM 203 and executes the programs, thereby realizing various functions of the delivery management server 200.

Furthermore, the delivery management server 200 includes a communication I/F 205, which is for communicating with the outside; a display mechanism 206, such as a display (that is, a display screen); and an input device 207, such as a keyboard, a mouse, and a touchscreen.

As the hardware configuration of the client terminal 300, for example, one that is the same as or similar to the hardware configuration of the delivery management server 200 illustrated in FIG. 3 may be used. Note that the client terminal 300 is provided with a camera (not illustrated) for capturing a still image or a moving image.

### Functional Configuration of Parcel Delivery System

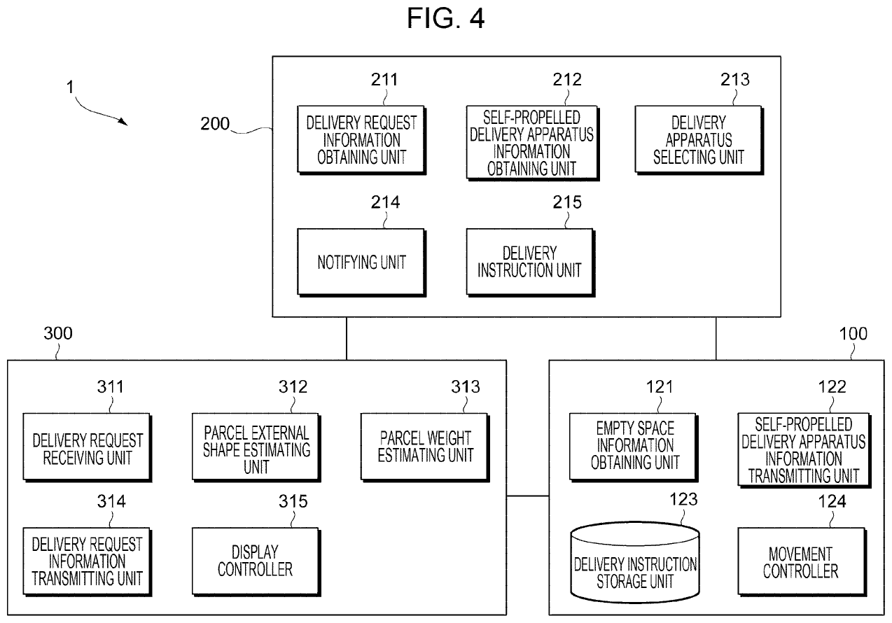

Next, the functional configuration of the parcel delivery system 1 according to the present exemplary embodiment will be described. FIG. 4 is a block diagram illustrating an exemplary functional configuration of the parcel delivery system 1 according to the exemplary embodiment. In the present exemplary embodiment, the delivery management server 200 includes a delivery request information obtaining unit 211, a self-propelled delivery apparatus information obtaining unit 212, a delivery apparatus selecting unit 213, a notifying unit 214, and a delivery instruction unit 215. The client terminal 300 includes a delivery request receiving unit 311, a parcel external shape estimating unit 312, a parcel weight estimating unit 313, a delivery request information transmitting unit 314, and a display controller 315. The self-propelled delivery apparatus 100 includes an empty space information obtaining unit 121, a self-propelled delivery apparatus information transmitting unit 122, a delivery instruction storage unit 123, and a movement controller 124.

At first, the functional configuration of the delivery management server 200 will be described.

In response to a delivery request from the client, the delivery request information obtaining unit 211 obtains information regarding the parcel delivery request from the client terminal 300. The information regarding the delivery request includes the sender of the parcel, the recipient of the parcel, parcel information, and the like. The sender of the parcel is, for example, the address of the client. In addition, the parcel information is, for example, the number of parcels, information regarding the external shape of the parcel, information regarding the weight of the parcel, the type of the parcel, and the like. More specifically, the information regarding the external shape of the parcel includes, for example, a captured image of the external shape of the parcel, information on the external size of the parcel, and the like. In addition, the information regarding the weight of the parcel includes, for example, a captured image of the contents of the parcel, information on the weight of the parcel, and the like.

The self-propelled delivery apparatus information obtaining unit 212 obtains information on the self-propelled delivery apparatus 100 from the self-propelled delivery apparatus 100. The information on the self-propelled delivery apparatus 100 includes the current position of the self-propelled delivery apparatus 100, information regarding empty space in the parcel storage unit 112 of the self-propelled delivery apparatus 100, and the like. More specifically, the information regarding empty space in the parcel storage unit 112 includes, for example, information on the size of the empty space in the parcel storage unit 112, and information on the weight of a parcel accommodable in the empty space in the parcel storage unit 112.

Note that the self-propelled delivery apparatus information obtaining unit 212 may request the self-propelled delivery apparatus 100 to transmit information, or may obtain information voluntarily transmitted from the self-propelled delivery apparatus 100. In addition, if there are multiple self-propelled delivery apparatuses 100 operating in the parcel delivery system 1, the self-propelled delivery apparatus information obtaining unit 212 obtains information from each of these self-propelled delivery apparatuses 100.

On the basis of the information obtained by the delivery request information obtaining unit 211 and the information obtained by the self-propelled delivery apparatus information obtaining unit 212, the delivery apparatus selecting unit 213 selects the self-propelled delivery apparatus 100 that performs delivery requested by the client. Here, on the basis of the information regarding the external shape of the parcel, the delivery apparatus selecting unit 213 selects the self-propelled delivery apparatus 100 that performs delivery by taking into consideration the empty space in the self-propelled delivery apparatus 100. More specifically, the delivery apparatus selecting unit 213 compares the external size of the parcel requested to be delivered with the empty space in the parcel storage unit 112 of the self-propelled delivery apparatus 100, and determines whether or not the parcel is accommodable in the self-propelled delivery apparatus 100. The delivery apparatus selecting unit 213 selects the self-propelled delivery apparatus 100 that has empty space capable of accommodating the parcel.

In addition, on the basis of the weight of the parcel requested to be delivered, along with the external size of the parcel requested to be delivered, the delivery apparatus selecting unit 213 selects the self-propelled delivery apparatus 100 that performs the delivery. More specifically, the delivery apparatus selecting unit 213 selects the self-propelled delivery apparatus 100 capable of accommodating the parcel in terms of weight on the basis of the weight of the parcel requested to be delivered and the weight of a parcel accommodable in the empty space in the parcel storage unit 112 of the self-propelled delivery apparatus 100 (that is, a deliverable weight).

Here, in the case where the self-propelled delivery apparatus 100 is capable of accommodating the parcel in terms of weight but the external size of the parcel exceeds the empty space, if the exceeding amount is within a predetermined range (such as within several tens of millimeters), the delivery apparatus selecting unit 213 selects that self-propelled delivery apparatus 100 as a candidate to perform the delivery. In this case, as will be described later, the client terminal 300 is notified of information regarding the empty space in the selected self-propelled delivery apparatus 100.

The notifying unit 214 notifies the client terminal 300 of the fact that the self-propelled delivery apparatus 100 that delivers the parcel has been selected. In addition, in the case where a self-propelled delivery apparatus 100 that is capable of accommodating the parcel in terms of weight but the external size of the parcel exceeds the empty space has been selected as a candidate to perform the delivery, the notifying unit 214 notifies the client terminal 300 of information regarding the empty space in the selected self-propelled delivery apparatus 100. The client terminal 300 is notified of information such as an image of the empty space, information on the size of the empty space, information indicating how much the parcel exceeds the empty space, and the like. More specifically, the information indicating how much the parcel exceeds the empty space includes, for example, an image where the external shape of the parcel and the empty space are superimposed on each other, information on the length that the parcel exceeds the empty space, and the like. In the present exemplary embodiment, the information indicating how much the parcel exceeds the empty space is an example of information indicating a state in which a parcel is not accommodable in space.

The delivery instruction unit 215 instructs the self-propelled delivery apparatus 100 determined to deliver the parcel to deliver the parcel.

The functional units of the delivery management server 200 are realized by cooperation between software and hardware resources. Specifically, for example, in the case where the delivery management server 200 is realized by the hardware configuration illustrated in FIG. 3, various programs stored in the HDD 204 or the like are loaded to the RAM 203 and executed by the CPU 201, thereby realizing the functional units illustrated in FIG. 4.

In the present exemplary embodiment, the delivery request information obtaining unit 211 is used as an example of a receiving unit. The delivery apparatus selecting unit 213 is used as an example of a selecting unit. The notifying unit 214 is used as an example of a notifying unit.

Next, the functional configuration of the client terminal 300 will be described.

The delivery request receiving unit 311 receives a delivery request from the client. Here, the delivery request receiving unit 311 receives, as information regarding a delivery request, the sender of the parcel, the recipient of the parcel, parcel information, and the like from the client.

Here, as part of the parcel information, the external size of the parcel is estimated from a captured image obtained by taking a picture of the parcel with a camera of the client terminal 300 or the like. If the client knows the size of the parcel, the client may input the value that the client knows.

In addition, as part of the parcel information, the weight of the parcel is estimated from a captured image obtained by taking a picture of the contents of the parcel with the camera of the client terminal 300 or the like. If the client knows the weight of the parcel, the client may input the value that the client knows.

Note that a captured image may be a picture taken with the camera of the client terminal 300 or with another apparatus.

The parcel external shape estimating unit 312 estimates the external size of the parcel from a captured image obtained by taking a picture of the external shape of the parcel. A process of estimating the external size of the parcel from the captured image will be described in detail later.

The parcel weight estimating unit 313 estimates the weight of the parcel from a captured image obtained by taking a picture of the contents of the parcel. Here, the parcel weight estimating unit 313 additionally estimates the type of the parcel from a captured image obtained by taking a picture of the contents of the parcel. A process of estimating the weight of the parcel from the captured image will be described in detail later.

The delivery request information transmitting unit 314 transmits information regarding the parcel delivery request to the delivery management server 200. Here, the delivery request information transmitting unit 314 transmits information regarding the sender of the parcel, the recipient of the parcel, the number of parcels, the external shape of the parcel, the weight of the parcel, and the like. More specifically, the information regarding the external shape of the parcel includes, for example, a captured image of the external shape of the parcel, information on the external size of the parcel estimated by the parcel external shape estimating unit 312, and the like. In addition, the information regarding the weight of the parcel includes, for example, a captured image of the contents of the parcel, information on the weight of the parcel estimated by the parcel weight estimating unit 313, information on the type of the parcel, and the like.

In other words, the delivery request information transmitting unit 314 requests the delivery management server 200 to have the delivery done by the self-propelled delivery apparatus 100 capable of accommodating the parcel having a size estimated by the parcel external shape estimating unit 312.

The display controller 315 outputs data for displaying a screen on a display provided on the client terminal 300, and controls displaying of the display. Here, the display controller 315 displays, for example, a screen used in the case of estimating the external size of the parcel or a screen used in the case of estimating the weight of the parcel. In addition, the display controller 315 displays the external shape of the parcel and the empty space that are superimposed on each other in the case where the self-propelled delivery apparatus 100 is capable of accommodating the parcel in terms of weight but the external size of the parcel exceeds the empty space.

The functional units of the client terminal 300 are realized by cooperation between software and hardware resources, like the delivery management server 200. Specifically, for example, various programs stored in the HDD or the like are loaded to the RAM and executed by the CPU, thereby realizing the functional units illustrated in FIG. 4.

In the present exemplary embodiment, the parcel external shape estimating unit 312 is used as an example of an estimating unit. The delivery request information transmitting unit 314 is used as an example of a requesting unit. The parcel weight estimating unit 313 is used as an example of an obtaining unit.

Next, the functional configuration of the self-propelled delivery apparatus 100 will be described.

The empty space information obtaining unit 121 obtains information regarding empty space in the parcel storage unit 112. Here, the empty space information obtaining unit 121 grasps the size of the empty space in the parcel storage unit 112 from a captured image of the parcel storage unit 112, which is captured using the parcel storage unit camera 108. In addition, the empty space information obtaining unit 121 grasps the weight of a parcel accommodable in the empty space in the parcel storage unit 112 (that is, a deliverable weight) from the weight of the parcel measured by the weight measurement unit 113.

The self-propelled delivery apparatus information transmitting unit 122 transmits information on the current position of the self-propelled delivery apparatus 100, and information regarding the empty space, which is obtained by the empty space information obtaining unit 121, to the delivery management server 200. Here, the self-propelled delivery apparatus information transmitting unit 122 may transmit information in response to a request from the delivery management server 200, or may voluntarily transmit information to the delivery management server 200. For example, the self-propelled delivery apparatus information transmitting unit 122 may voluntarily transmit information at a time point at which the number of parcels accommodated in the parcel storage unit 112 increases or decreases.

In response to an instruction from the delivery management server 200 to deliver a parcel, the delivery instruction storage unit 123 stores information on the delivery for which the instruction has been given. Here, as has been described above, information regarding the parcel delivery request such as the sender of the parcel, the recipient of the parcel, parcel information, and the like is registered.

In addition, in the case where information on a plurality of deliveries is stored in the delivery instruction storage unit 123, the order of performing these deliveries is determined. For example, the order of the deliveries is determined such that the deliveries will be performed in the order in which the delivery instructions are given. In addition, for example, the order may be changed to deliver one parcel before the delivery of another parcel in accordance with the details of the parcel delivery instructions.

The movement controller 124 controls the self-propelling mechanism 113 (see FIG. 2) to control the movement of the self-propelled delivery apparatus 100. For example, moving forward and backward, stop, and the direction of movement of the self-propelled delivery apparatus 100 are controlled. Here, the movement controller 124 controls movement of the self-propelled delivery apparatus 100 on the basis of information on deliveries, which is stored in the delivery instruction storage unit 123.

More specifically, the movement controller 124 controls the self-propelled delivery apparatus 100 to sequentially perform deliveries in accordance with information on the deliveries, which is stored in the delivery instruction storage unit 123. Here, on receipt of an instruction from the delivery management server 200 to deliver a parcel, the movement controller 124 controls the self-propelled delivery apparatus 100 to move to the sender of the parcel for which the delivery instruction has been given. If there is a parcel that has already been accommodated in the parcel storage unit 112 on receipt of a parcel delivery instruction, the self-propelled delivery apparatus 100 is controlled to move to the sender of the parcel for which the delivery instruction has been given, after or during delivery of the already-accommodated parcel. When the self-propelled delivery apparatus 100 arrives at the sender of the parcel, the parcel collection and delivery unit 111 collects the parcel. The movement controller 124 controls the self-propelled delivery apparatus 100 to start delivering the collected parcel or to resume the interrupted delivery of the parcel. When the self-propelled delivery apparatus 100 arrives at the recipient of the parcel, the parcel collection and delivery unit ill delivers the parcel. When delivery of the parcel is completed, the self-propelled delivery apparatus 100 notifies the delivery management server 200 and the client terminal 300 of the fact that the delivery of the parcel has been completed. The movement controller 124 controls the self-propelled delivery apparatus 100 to move to the recipient of the next to-be-delivered parcel.

The functional units of the self-propelled delivery apparatus 100 are realized by cooperation between software and hardware resources, like the delivery management server 200. Specifically, for example, in the case where the self-propelled delivery apparatus 100 is realized by the hardware configuration illustrated in FIG. 2, various programs stored in the HDD 104 or the like are loaded to the RAM 103 and executed by the CPU 101, thereby realizing the functional units illustrated in FIG. 4.

### Description of Process of Estimating External Size of Parcel

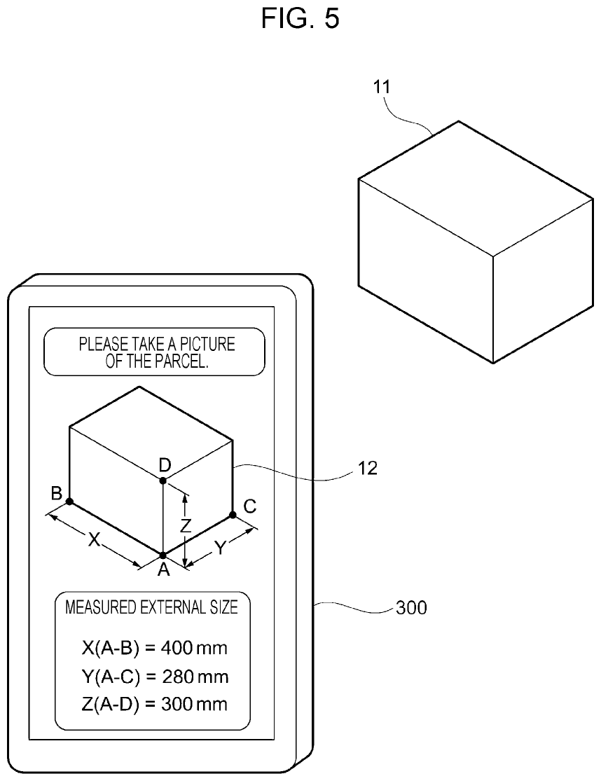

Next, a process of estimating, by the parcel external shape estimating unit 312 of the client terminal 300, the external size of a parcel from a captured image obtained by taking a picture of the external shape of the parcel will be described. FIG. 5 is a diagram for describing an exemplary process of estimating the external size of a parcel.

The client activates, for example, as an already-installed application on the client terminal 300, an application used for requesting delivery (hereinafter referred to as a delivery request application). In response to activation of the delivery request application, the parcel external shape estimating unit 312 of the client terminal 300 prompts the client to take a picture of the parcel. More specifically, a message prompting the client to take a picture of the parcel is displayed on a display of the client terminal 300. When the client takes a picture of the external shape of the to-be-delivered parcel with a camera, the parcel external shape estimating unit 312 obtains a captured image obtained by taking a picture of the external shape of the parcel. In addition, the captured image is displayed on the display of the client terminal 300.

Next, the parcel external shape estimating unit 312 prompts the client to designate reference points serving as reference for measurement in the captured image in order to estimate the external size of the parcel. More specifically, a message prompting the client to designate reference points serving as reference for measurement is displayed on the display of the client terminal 300. The client designate reference points serving as reference for measurement in the captured image.

In the example illustrated in FIG. 5, the client takes a picture of the external shape of a to-be-delivered parcel 11 with a camera, and a captured image 12 is displayed on the display of the client terminal 300. Here, the client designates point A as a reference point for measuring the width, depth, and height of the parcel 11 in the captured images 12. In addition, the client designates point B as a reference point for measuring the width of the parcel 11. Furthermore, the client designates point C as a reference point for measuring the depth of the parcel 11. In addition, the client designates point D as a reference point for measuring the height of the parcel 11. In this manner, the client designates reference points in the captured image 12, and the parcel external shape estimating unit 312 receives the designated reference points. The parcel external shape estimating unit 312 identifies the coordinates of the parcel 11 in three-dimensional space, and calculates the distance between reference points.

More specifically, the parcel external shape estimating unit 312 calculates the distance between point A and point B, thereby calculating the width of the parcel 11. For example, the width of the parcel 11 (the length of X in FIG. 5) is calculated as 400 mm. In addition, the parcel external shape estimating unit 312 calculates the distance between point A and point C, thereby calculating the depth of the parcel 11. For example, the depth of the parcel 11 (the length of Y in FIG. 5) is calculated as 280 mm. Furthermore, the parcel external shape estimating unit 312 calculates the distance between point A and point D, thereby calculating the height of the parcel 11. For example, the height of the parcel 11 (the length of Z in FIG. 5) is calculated as 300 mm. The parcel external shape estimating unit 312 calculates the width, depth, and height of the parcel 11, thereby estimating the three-dimensional external size of the parcel 11.

Note that, as a method of recognizing spatial positions from an image and calculating the distance between two points, for example, Apple's framework called ARKit may be used.

Alternatively, instead of based on the client's designation, the parcel external shape estimating unit 312 may identify reference points on the basis of the shape of a parcel or the like, and may calculate the distance between the identified reference points.

Furthermore, although the example illustrated in FIG. 5 indicates the case in which the parcel 11 is a rectangular parallelepiped, even when the parcel 11 is not a rectangular parallelepiped, the external size of the parcel 11 may be estimated by calculating the distance between reference points. For example, in the case where the parcel 11 is a cube, the diameter of the cube is calculated by calculating the distance between reference points, and accordingly, the external size of the parcel 11 is estimated.

### Description of Process of Estimating Weight of Parcel

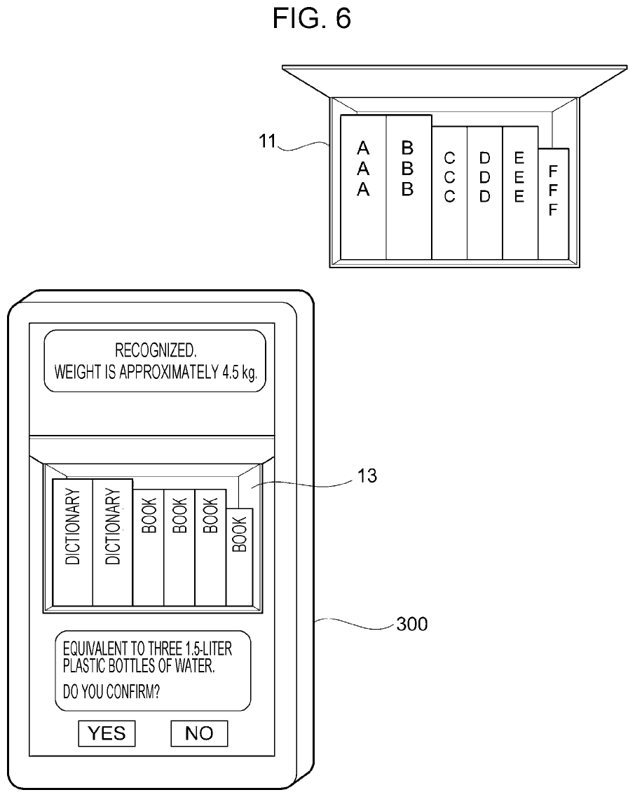

Next, a process of estimating, by the parcel weight estimating unit 313 of the client terminal 300, the weight of a parcel from a captured image obtained by taking a picture of the contents of the parcel will be described. FIG. 6 is a diagram for describing an exemplary process of estimating the weight of a parcel.

When the parcel external shape estimating unit 312 completes the estimation, the parcel weight estimating unit 313 prompts the client to take a picture of the contents of the parcel. More specifically, a message prompting the client to take a picture of the contents of the parcel is displayed on the display of the client terminal 300. When the client takes a picture of the contents of the parcel with a camera, the parcel weight estimating unit 313 obtains a captured image obtained by taking a picture of the contents of the parcel. In addition, the captured image is displayed on the display of the client terminal 300. In the example illustrated in FIG. 6, the client takes a picture of the contents of the to-be-delivered parcel 11 with a camera, and a captured image 13 is displayed on the display of the client terminal 300.

Here, the parcel weight estimating unit 313 performs image recognition processing on the captured image of the contents, and estimates the volume of the contents. More specifically, the parcel weight estimating unit 313 estimates the volume of the contents from the height of the contents in comparison with the height of a box in the captured image, the size of a gap on the bottom of the box, and the like. In the example illustrated in FIG. 6, the parcel weight estimating unit 313 estimates the volume of the contents as “4500 cm³”.

Alternatively, using the above-mentioned framework ARKit or the like, the spatial position in three-dimensional space may be recognized from the captured image of the contents of the parcel, and the coordinates in the three-dimensional space of, for example, the height of the contents in comparison with the height of a box are identified, thereby estimating the volume of the parcel.

Furthermore, the parcel weight estimating unit 313 estimates the type of the contents by image-recognizing, from the captured image, the shape and pattern of the contents, text written on the contents, and the like. For example, the type of the contents is estimated by collating information accumulated in a database as information according to each type against information obtained by image recognition. In addition, for example, the type of the contents may be estimated by inputting an image of the contents to a program for determining the contents (a program prepared in advance using a method such as machine learning or deep learning). In the example illustrated in FIG. 6, six books are packed in a box, and the parcel weight estimating unit 313 estimates that the contents are six books (two of which are dictionaries). The estimated type of the contents is displayed on the display of the client terminal 300.

Here, the client may correct the estimated type of the contents if the estimated type is incorrect. For example, when the client selects the contents on the screen, candidates for the type of the contents are displayed by a pull-down menu. The client may simply select the actual type from among the displayed candidates. Alternatively, the client may directly input text indicating the type, such as “books”.

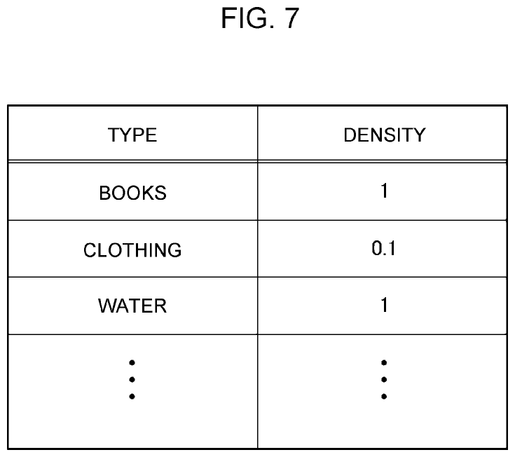

Next, the parcel weight estimating unit 313 estimates the weight of the contents from the estimated volume of the contents and the estimated type of the contents. Here, information on density is predetermined for each type of contents. FIG. 7 is a diagram illustrating exemplary information on density defined for each type of contents. In the example illustrated in FIG. 7, the density of books, clothing, and water are defined as 1 g/cm³, 0.1 g/cm³, and 1 g/cm³, respectively. Because the parcel weight estimating unit 313 has estimated the contents as six books, the density “1 g/cm³” is adopted. In addition, as has been described above, the parcel weight estimating unit 313 estimates the volume of the contents as “4500 cm³”. Thus, the weight of the contents is estimated as “4.5 kg”. The estimated weight of the contents is displayed on the display of the client terminal 300, as illustrated in FIG. 6.

In addition, even when the value of weight of the contents is displayed, the client may not intuitively know how heavy the weight is. Therefore, information on a comparison target having a weight equivalent to the weight of the contents may be displayed. In the example illustrated in FIG. 6, as information on a comparison target having a weight equivalent to the weight of the contents, a value converted to plastic bottles of water is displayed. Because the weight of the contents is estimated as 4.5 kg, this weight is converted to three 1.5-liter plastic bottles of water.

The client checks the estimated value of weight and the converted value of weight, and, if the value greatly differs from the actual weight of the contents, the client may simply input that the estimated weight is incorrect. When it is input that the estimated weight is incorrect, for example, the parcel weight estimating unit 313 again performs the estimating process, or a process of directly receiving the value of weight of the contents from the client is performed.

Alternatively, the parcel weight estimating unit 313 may inquire an external apparatus such as the delivery management server 200 to obtain information on the type of the contents, which is estimated from the captured image, or to obtain information on density corresponding to the type of the contents. In addition, the information on the contents once inquired may be registered in the delivery request application, and the client may refer to the registered information from the next time.

### Description of Process of Obtaining Information on Empty Space

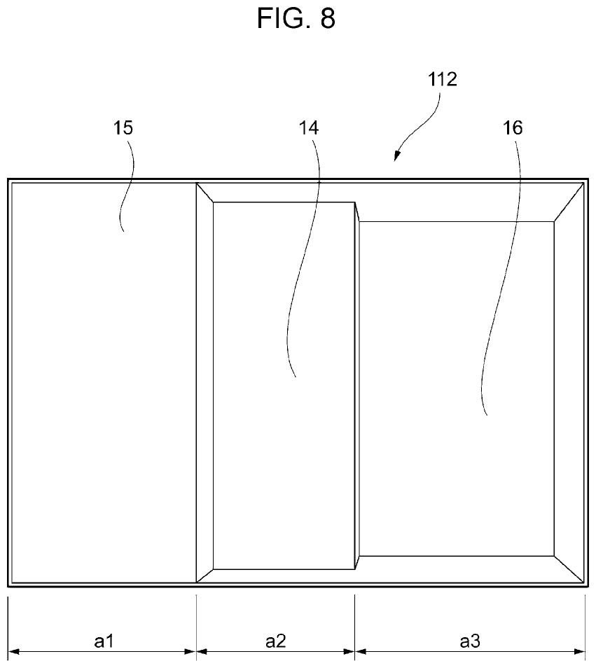

Next, a process of obtaining, by the empty space information obtaining unit 121 of the self-propelled delivery apparatus 100, information on empty space in the parcel storage unit 112 will be described. FIG. 8 is a diagram illustrating an exemplary captured image of the parcel storage unit 112, which is captured with the parcel storage unit camera 108.

The empty space information obtaining unit 121 performs image recognition processing on the captured image of the parcel storage unit 112, and estimates the size of empty space in the parcel storage unit 112. More specifically, the empty space information obtaining unit 121 estimates the size of the empty space from the height of the parcel in comparison with the height of the parcel storage unit 112 in the captured image, the size of a gap on the bottom of the parcel storage unit 112, and the like.

In the example illustrated in FIG. 8, it is illustrated that a parcel 14 and a parcel 15 are accommodated in the parcel storage unit 112, and the remaining portion is empty space 16. Here, the empty space information obtaining unit 121 estimates the size of the empty space 16 from the difference between the height of each of the parcel 14 and the parcel 15 and the height of the parcel storage unit 112, and the difference between the width of the parcel 14 and the parcel 15 and the width of the parcel storage unit 112. More specifically, for example, it is possible to accommodate a parcel within the limit of the remaining width a3 excluding the width a1 of the parcel 14 and the width a2 of the parcel 15. In addition, for example, because the space above the parcel 15 is empty, another parcel may be stacked on the parcel 15 and accommodated.

Alternatively, using the above-mentioned framework ARKit or the like, the spatial position in three-dimensional space may be recognized from the captured image of the parcel storage unit 112, and the coordinates in the three-dimensional space of, for example, the height of the parcel 15 in comparison with the height of the parcel storage unit 112 are identified, thereby estimating the size of the empty space.

In addition, the empty space information obtaining unit 121 grasps the weight of a parcel accommodable in the empty space in the parcel storage unit 112 from the weight of a parcel measured by the weight measurement unit 113. In the example illustrated in FIG. 8, the weight measurement unit 113 measures the weight of the parcel 14 and the parcel 15. In addition, the upper limit value of the weight of a parcel accommodable in the parcel storage unit 112 (that is, the maximum weight of a parcel accommodable when the parcel storage unit 112 is empty) is predetermined. The empty space information obtaining unit 121 grasps the weight of a parcel accommodable in the empty space 16 by subtracting the weight of the parcel 14 and the parcel 15 from the upper limit value of the accommodable parcel.

The self-propelled delivery apparatus information transmitting unit 122 transmits information on the size of the empty space 16 and information on the weight of a parcel accommodable in the empty space 16, which are grasped by the empty space information obtaining unit 121, to the delivery management server 200.

### Description of Process of Determining Whether Parcel is Accommodable

Next, a process of determining, by the delivery apparatus selecting unit 213 of the delivery management server 200, whether a parcel is accommodable in the self-propelled delivery apparatus 100 by comparing the external shape of the parcel with empty space in the self-propelled delivery apparatus 100.

The delivery apparatus selecting unit 213 grasps the external size of the parcel on the basis of information on the external size of the parcel, received by the delivery request information obtaining unit 211. In addition, the delivery apparatus selecting unit 213 grasps the size of empty space in the parcel storage unit 112 on the basis of information on the size of empty space in the parcel storage unit 112, obtained by the self-propelled delivery apparatus information obtaining unit 212. The delivery apparatus selecting unit 213 determines whether the parcel is accommodable in the self-propelled delivery apparatus 100 by comparing the two sizes.

More specifically, the delivery apparatus selecting unit 213 compares, for example, the bottom and sides of the parcel with the bottom and sides of the empty space. In the case where the bottom of the empty space is larger than the bottom of the parcel and the sides of the empty space are larger than the sides of the parcel, the delivery apparatus selecting unit 213 determines that the parcel is accommodable.

In addition, for example, if the parcel is not instructed to be carried right side up and the parcel may be carried upside down, the delivery apparatus selecting unit 213 may change the orientation of the parcel and compare the bottom and sides of the parcel whose direction has been changed with the bottom and sides of the empty space. If the parcel is not instructed to be carried right side up, the parcel may be turned over in any direction. Thus, the delivery apparatus selecting unit 213 determines that, given the fact that the parcel has been turned over in any direction, the parcel is accommodable when the bottom of the empty space is larger than the bottom of the parcel and the sides of the empty space are larger than the sides of the parcel.

Furthermore, it may be set in advance whether a new parcel is allowed to be placed in the space above an existing parcel. For example, the common setting may be set for all parcels, or the setting may be changed according to each parcel or each type of parcel. Alternatively, whether a new parcel is allowed to be placed over an existing parcel may be determined in accordance with the weight of the new parcel or the durability of the existing parcel.

Display Example in which External Shape of Parcel and Empty Space are Superimposed on Each Other

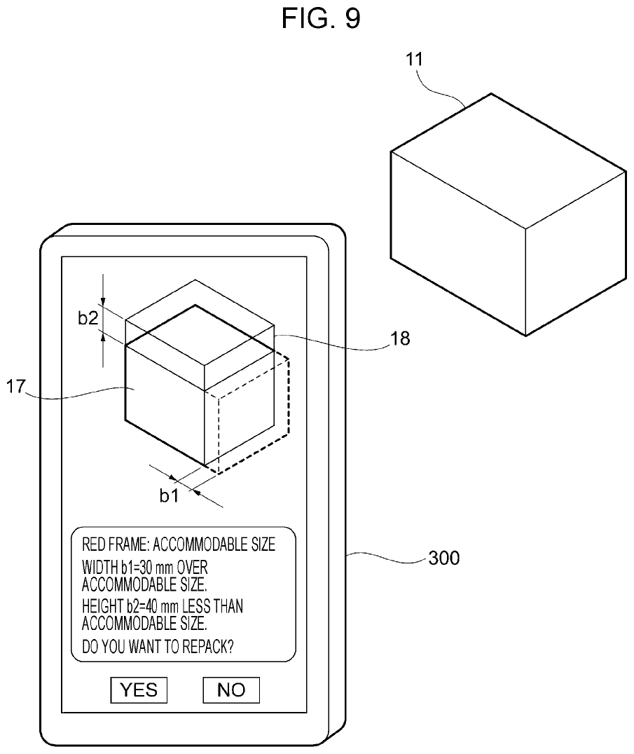

Next, a specific example of display in which the external shape of a parcel and empty space are superimposed on each other will be described. FIG. 9 is a diagram illustrating a display example in which the external shape of a parcel and empty space are superimposed on each other. The display controller 315 displays the external shape of a parcel and empty space that are superimposed on each other in the case where the self-propelled delivery apparatus 100 is capable of accommodating the parcel in terms of weight but the external size of the parcel exceeds the empty space.

In the example illustrated in FIG. 9, an image 17 of the external shape of the parcel 11, and an image 18 indicating empty space in the self-propelled delivery apparatus 100 are displayed one above the other. The image 17 is, for example, a captured image of the parcel 11 which is a picture of the parcel 11 taken by the client with the camera of the client terminal 300. In addition, the image 18 is, for example, a captured image captured with the parcel storage unit camera 108 of the self-propelled delivery apparatus 100. That is, the image 18 indicates the size of a parcel accommodable in the parcel storage unit 112 of the self-propelled delivery apparatus 100. It is indicated that the external shape of the parcel in the image 17 exceeds the empty space in the image 18, and the width of the external shape of the parcel exceeds the empty space by b1 (30 mm in the illustrated example). In addition, it is indicated that the height of the empty space is sufficient for the parcel, and the height of the parcel may be increased by b2 (40 mm in the illustrated example).

By displaying the external shape of the parcel 11 and the empty space one above the other in this manner, the client is notified of in which direction of the width, depth, and height the parcel 11 exceeds the empty space, and in which direction of the width, depth, and height and how much the empty space is sufficient for the parcel 11. If the client reduces the size of the parcel in the width direction or increases the size of the parcel in the height direction and repacks the contents and the parcel becomes accommodable in the empty space, the self-propelled delivery apparatus 100 is instructed to deliver the parcel.

The display controller 315 may obtain an image where the external shape of the parcel and the empty space are superimposed on each other from the delivery management server 200 and display the image, or may display the external shape of the parcel and the empty space one above the other on the basis of information on the empty space obtained from the delivery management server 200.

In addition, display in which the external shape of the parcel 11 and the empty space are superimposed on each other need not be a captured image of the external shape of the parcel 11 and a captured image of the empty space that are superimposed on each other. For example, these captured images may be simplified and superimposed on each other. These captured images may be superimposed on each other any way as long as the difference between the external size of the parcel 11 and the size of the empty space is shown.

### Series of Processing Steps Performed by Parcel Delivery System

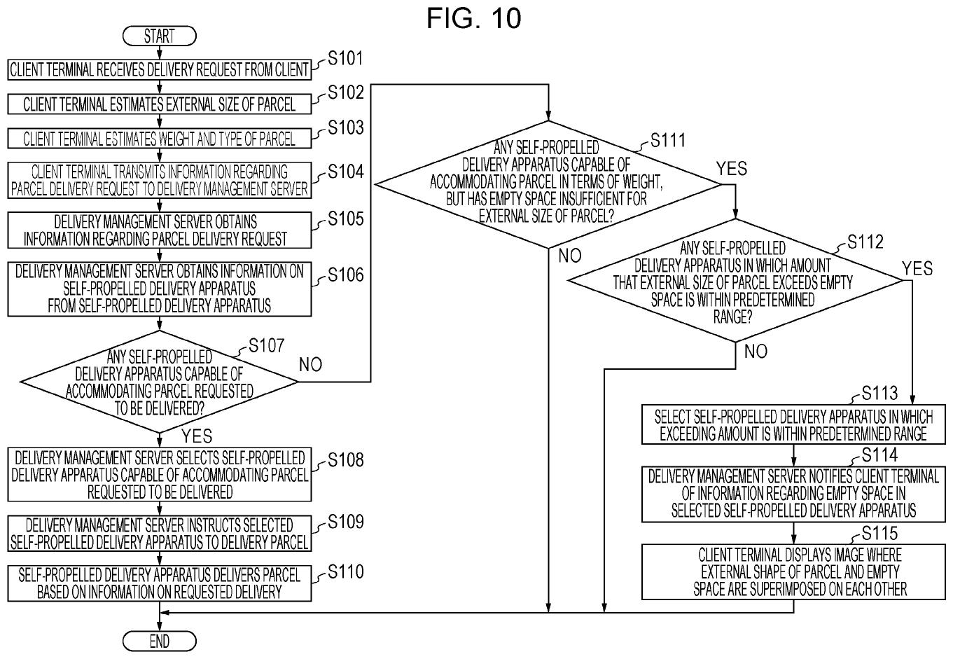

Next, the flow of a series of processing steps performed by the parcel delivery system 1 according to the present exemplary embodiment will be described. FIG. 10 is a flowchart illustrating an example of a series of processing steps performed by the parcel delivery system 1 according to the present exemplary embodiment.

Hereinafter, steps of a process may be represented as the symbol “S”.

At first, the delivery request receiving unit 311 of the client terminal 300 receives a delivery request from the client (S101). Here, the client inputs information regarding the delivery request, such as the sender of the parcel, the recipient of the parcel, parcel information, and the like.

In addition, when the client takes a picture of the external shape of the parcel with the camera of the client terminal 300 or the like, the parcel external shape estimating unit 312 of the client terminal 300 estimates the external size of the parcel from a captured image obtained by taking a picture of the external shape of the parcel (S102).

Furthermore, when the client takes a picture of the contents of the parcel with the camera of the client terminal 300 or the like, the parcel weight estimating unit 313 of the client terminal 300 estimates the weight and type of the parcel from a captured image obtained by taking a picture of the contents the parcel (S103).

Note that the client may input the size, weight, and type of the parcel if the client knows these items of information.

Next, the delivery request information transmitting unit 314 of the client terminal 300 transmits the information regarding the parcel delivery request to the delivery management server 200 (S104). The delivery request information obtaining unit 211 of the delivery management server 200 obtains the information regarding the parcel delivery request from the client terminal 300 (S105).

Next, the self-propelled delivery apparatus information obtaining unit 212 of the delivery management server 200 obtains information on a self-propelled delivery apparatus 100 from the self-propelled delivery apparatus 100 (S106). For example, the self-propelled delivery apparatus information obtaining unit 212 may request a self-propelled delivery apparatus 100 to transmit information, and obtain the information from the self-propelled delivery apparatus 100. Next, the delivery apparatus selecting unit 213 of the delivery management server 200 determines whether there is a self-propelled delivery apparatus 100 capable of accommodating the parcel requested to be delivered, on the basis of the information regarding the parcel delivery request and information regarding empty space in the self-propelled delivery apparatus 100 (S107).

In step S107, the determination is affirmative (YES) in the case where there is a self-propelled delivery apparatus 100 that has empty space whose size is sufficient for accommodating the parcel requested to be delivered, and the weight of a parcel accommodable in the parcel storage unit 112 is greater than the weight of the parcel requested to be delivered. In contrast, the determination is negative (NO) in the case where there is no such self-propelled delivery apparatus 100 satisfying these conditions.

In the case where the determination in step S107 is affirmative (YES), the delivery apparatus selecting unit 213 of the delivery management server 200 selects a self-propelled delivery apparatus 100 capable of accommodating the parcel requested to be delivered (S108). Here, in the case where there are multiple self-propelled delivery apparatuses 100 having empty space whose size is sufficient for accommodating the parcel requested to be delivered, and the weight of a parcel accommodable in the parcel storage unit 112 is greater than the weight of the parcel requested to be delivered, the delivery apparatus selecting unit 213 selects one self-propelled delivery apparatus 100 from among these multiple self-propelled delivery apparatuses 100 in accordance with predetermined criteria.

The predetermined criteria here include, for example, the point that the self-propelled delivery apparatus 100 is one closest to the client, and has the largest empty space.

Next, the delivery instruction unit 215 of the delivery management server 200 instructs the selected self-propelled delivery apparatus 100 to deliver the parcel (S109). The self-propelled delivery apparatus 100 delivers the parcel on the basis of information on the delivery for which the instruction has been given (S110). Then, the processing flow ends.

In the case where the determination in step S107 is negative (NO), the delivery apparatus selecting unit 213 of the delivery management server 200 determines whether there is a self-propelled delivery apparatus 100 capable of accommodating the parcel in terms of weight but has empty space whose size is insufficient for the external size of the parcel (S111).

In the case where the determination in step S111 is negative (NO), the processing flow ends. In this case, the parcel delivery request is not accepted, and, for example, the delivery management server 200 notifies the client terminal 300 of the fact that the parcel delivery request is unacceptable.

In contrast, in the case where the determination in step S111 is affirmative (YES), the delivery apparatus selecting unit 213 determines whether there is a self-propelled delivery apparatus 100 in which the amount that the external size of the parcel exceeds the empty space is within a predetermined range (S112). In the case where the determination in step S112 is negative (NO), the processing flow ends, as in the case where the determination in step S111 is negative (NO). In contrast, in the case where the determination in step S112 is affirmative (YES), the delivery apparatus selecting unit 213 selects the self-propelled delivery apparatus 100 in which the exceeding amount is within the predetermined range as a candidate to perform the delivery (S113). Here, if there are multiple self-propelled delivery apparatuses 100 in which the exceeding amount is within the predetermined range, the delivery apparatus selecting unit 213 selects one self-propelled delivery apparatus 100 from among these multiple self-propelled delivery apparatuses 100 in accordance with predetermined criteria.

The predetermined criteria here include, for example, the point that the self-propelled delivery apparatus 100 is one closest to the client, has the largest empty space, and has the smallest exceeding amount.

Next, the notifying unit 214 of the delivery management server 200 notifies the client terminal 300 of information regarding the empty space in the selected self-propelled delivery apparatus 100 (S114). On the basis of the information reported from the self-propelled delivery apparatus 100, the client terminal 300 displays an image where the external shape of the parcel and the empty space are superimposed on each other as display in the case where the self-propelled delivery apparatus 100 is capable of accommodating the parcel in terms of weight but the external size of the parcel exceeds the empty space (S115). Then, the processing flow ends. For example, the client may repack the contents and again make a delivery request.

### Procedure of Estimating External Size of Parcel

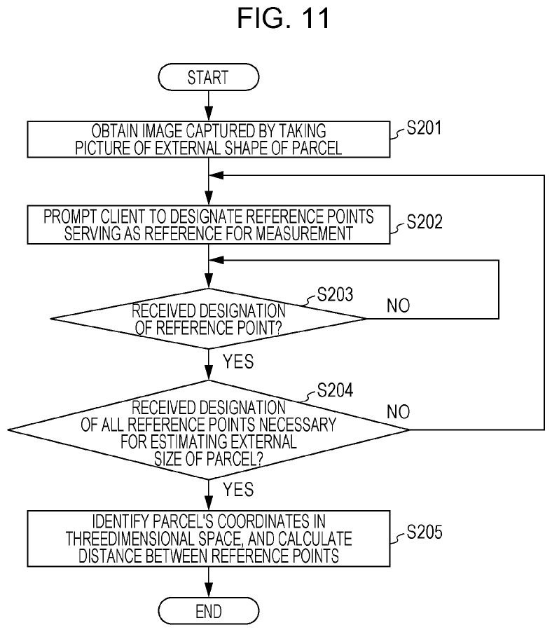

Next, a procedure of estimating, by the parcel external shape estimating unit 312 of the client terminal 300, the external size of a parcel from a captured image obtained by taking a picture of the external shape of the parcel will be described. FIG. 11 is a flowchart illustrating an example of a procedure of estimating the external size of a parcel, which is performed by the parcel external shape estimating unit 312 of the client terminal 300. It is assumed that, as an initial state, the client activates the delivery request application on the client terminal 300 to make the client terminal 300 ready to receive a delivery request.

When the client takes a picture of the external shape of the to-be-delivered parcel with the camera of the client terminal 300, the parcel external shape estimating unit 312 obtains a captured image obtained by taking a picture of the external shape of the parcel (S201). Here, the captured image is displayed on the display of the client terminal 300. Next, the parcel external shape estimating unit 312 prompts the client to designate reference points serving as reference for measurement in the captured image (S202). Next, the parcel external shape estimating unit 312 determines whether the client's designation of reference points has been received (S203).

In the case where the determination in step S203 is negative (NO), the parcel external shape estimating unit 312 continuously makes a determination in step S203, and waits until designation of reference points is received. Alternatively, the flow may proceed to step S202 to again prompt the client to designate reference points.

In the case where the determination in step S203 is affirmative (YES), the parcel external shape estimating unit 312 determines whether designation of all reference points necessary for estimating the external size of the parcel has been received (S204). For example, in the case where the parcel is a rectangular parallelepiped, it is determined whether designation of reference points for measuring the width of the parcel, reference points for measuring the depth of the parcel, and reference points for measuring the height of the parcel has been received.

In the case where the determination in step S204 is negative (NO), the flow proceeds to step S202.

In contrast, in the case where the determination in step S204 is affirmative (YES), the parcel external shape estimating unit 312 identifies the coordinates of the parcel in three-dimensional space, and calculates the distance between reference points (S205). For example, the parcel external shape estimating unit 312 calculates the width, depth, and height of the parcel, thereby estimating the external size of the parcel. Then, the processing flow ends.

### Procedure of Estimating Weight of Parcel

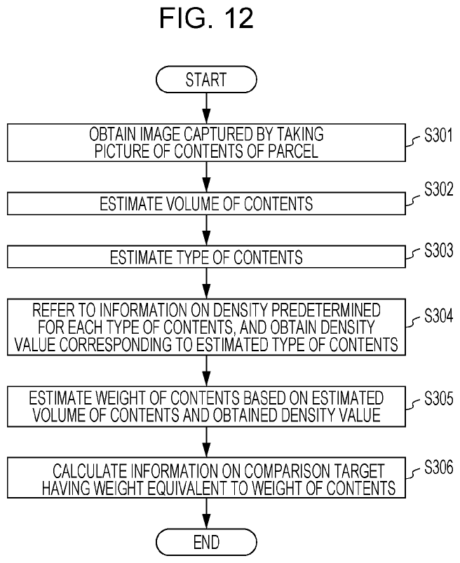

Next, a procedure of estimating, by the parcel weight estimating unit 313 of the client terminal 300, the weight of a parcel from a captured image obtained by taking a picture of the contents of the parcel will be described. FIG. 12 is a flowchart illustrating an example of a procedure of estimating the weight of a parcel, which is performed by the parcel weight estimating unit 313 of the client terminal 300. It is assumed that, as an initial state, the client activates the delivery request application on the client terminal 300 to make the client terminal 300 ready to receive a delivery request.

At first, when the client takes a picture of the contents of the to-be-delivered parcel with the camera of the client terminal 300, the parcel weight estimating unit 313 obtains a captured image obtained by taking a picture of the contents of the parcel (S301). Here, the captured image is displayed on the display of the client terminal 300. Next, the parcel weight estimating unit 313 performs image recognition processing on the captured image of the contents, and estimates the volume of the contents from the height of the contents, a gap on the bottom of a box containing the contents, and the like (S302).

Next, the parcel weight estimating unit 313 estimates the type of the contents by image-recognizing, from the captured image of the contents, the shape and pattern of the contents, text written on the contents, and the like (S303). Here, the estimated type of the contents is displayed on the display of the client terminal 300. The client may check the displayed type of the contents and, if the type of the contents is incorrect, may change it to the correct type.

Next, the parcel weight estimating unit 313 refers to information on density predetermined for each type of contents, and obtains the value of density corresponding to the estimated type of the contents (S304). Next, the parcel weight estimating unit 313 estimates the weight of the contents from the estimated volume of the contents and the obtained value of density (S305). Here, the estimated weight of the contents is displayed on the display of the client terminal 300.

Furthermore, the parcel weight estimating unit 313 calculates information on a comparison target having a weight equivalent to the weight of the contents (S306). For example, in the case where the estimated weight of the contents is 4.5 kg, this weight is converted to three 1.5-liter plastic bottles of water. The information on this comparison target is displayed on the display of the client terminal 300. The client may check the estimated weight of the contents and the information on the comparison target, and, if the estimated weight of the contents is incorrect, may change it to the correct weight value.

As has been described above, the parcel delivery system 1 according to the present exemplary embodiment estimates the external size and weight of a parcel from captured images. The parcel delivery system 1 selects a self-propelled delivery apparatus 100 that performs delivery on the basis of the estimated external size and weight of the parcel, and information on empty space in the self-propelled delivery apparatus 100. Thus, whether the self-propelled delivery apparatus 100 is capable of collecting the client's parcel is determined before the self-propelled delivery apparatus 100 comes to collect the parcel.

Although the self-propelled delivery apparatus 100 that delivers a parcel is selected on the basis of both the external size of the parcel and the weight of the parcel, the self-propelled delivery apparatus 100 may be selected on the basis of only one of the external size of the parcel and the weight of the parcel.

For example, the self-propelled delivery apparatus 100 may be selected on the basis of the external size of the parcel, without taking into consideration the weight of the parcel. In this case, in the case where the self-propelled delivery apparatus 100 is capable of accommodating the parcel in terms of weight but the external size of the parcel exceeds the empty space, an image where the external shape of the parcel and the empty space are superimposed on each other is displayed on the client terminal 300.

Likewise, for example, the self-propelled delivery apparatus 100 may be selected on the basis of the weight of the parcel, without taking into consideration the external size of the parcel.

In the present exemplary embodiment, on receipt of a delivery request, the delivery management server 200 selects the self-propelled delivery apparatus 100 that performs delivery by taking into consideration empty space in the self-propelled delivery apparatus 100 at that time. Alternatively, the delivery management server 200 may select the self-propelled delivery apparatus 100 that performs delivery not by taking into consideration the empty space at the time point of receipt of the delivery request, but by taking into consideration the empty space at a future time point.

More specifically, for example, the self-propelled delivery apparatus 100 stores information on delivery that is stored in the delivery instruction storage unit 123 and a parcel accommodated in the parcel storage unit 112 in association with each other. The self-propelled delivery apparatus 100 grasps how much the empty space in the parcel storage unit 112 increases when delivery of each parcel is completed. In addition, the self-propelled delivery apparatus 100 calculates the delivery start time and end time for each parcel on the basis of information on the order of deliveries, the sender of a parcel in each delivery, the recipient of the parcel, and the like. In this manner, the self-propelled delivery apparatus 100 grasps temporal change of empty space in the parcel storage unit 112 by storing a delivery and a parcel in association with each other and by calculating the delivery start time and end time. On the basis of the temporal change of empty space grasped by each self-propelled delivery apparatus 100, the delivery management server 200 selects the self-propelled delivery apparatus 100 that performs delivery by taking into consideration not only the current empty space but also the empty space in future.

More specifically, for example, on receipt of a delivery request from the client, the delivery management server 200 takes into consideration the empty space at that time point in a self-propelled delivery apparatus 100 whose parcel storage unit 112 accommodates no parcel, among one or more self-propelled delivery apparatuses 100. In addition, regarding a self-propelled delivery apparatus 100 currently delivering a parcel, the delivery management server 200 takes into consideration the empty space at a time point at which delivery of the parcel is completed. The delivery management server 200 selects the self-propelled delivery apparatus 100 that performs delivery on the basis of the empty space in each self-propelled delivery apparatus 100 that is to be taken into consideration.

In addition, for example, the delivery management server 200 calculates the time at which a parcel requested to be delivered becomes accommodable in each self-propelled delivery apparatus 100 on the basis of temporal change of the empty space in one or more self-propelled delivery apparatuses 100. The delivery management server 200 selects a self-propelled delivery apparatus 100 whose calculated time is the earliest as the self-propelled delivery apparatus 100 that performs delivery. Here, for each self-propelled delivery apparatus 100, not only the time at which a parcel requested to be delivered becomes accommodable, but also the time at which the amount that the external size of the parcel exceeds the empty space becomes within a predetermined range may be calculated. For example, out of the calculated times, in the case where the time at which the exceeding amount becomes within the predetermined range is earlier than the other, that self-propelled delivery apparatus 100 is selected as a candidate to perform delivery.

Instead of the self-propelled delivery apparatus 100, the delivery management server 200 or the client terminal 300 may calculate temporal change of the empty space in the self-propelled delivery apparatus 100.

In the present exemplary embodiment, processing performed by functional units realized by each of the self-propelled delivery apparatus 100, the delivery management server 200, and the client terminal 300 may be realized by another apparatus. For example, the parcel external shape estimating unit 312 and the parcel weight estimating unit 313 of the client terminal 300 may be realized by the delivery management server 200, and the delivery management server 200 may estimate the external size of a parcel from a captured image of the external shape of the parcel or estimate the weight of a parcel from a captured image of the contents of the parcel. Alternatively, for example, the delivery apparatus selecting unit 213 of the delivery management server 200 may be realized by the client terminal 300, and the client terminal 300 may select a self-propelled delivery apparatus 100 capable of accommodating a parcel requested to be delivered.

In addition, a program for realizing the exemplary embodiment of the present disclosure may be provided not only by a communication means but also by being stored in a recording medium such as compact disc read-only memory (CD-ROM).

Although various exemplary embodiments and modifications have been described above, these exemplary embodiments and modifications may be combined for configuration.

The present disclosure is not limited by the above-described exemplary embodiment, and may be implemented in various forms without departing from the scope of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A parcel delivery system comprising:
a receiving unit that receives information regarding an external shape of a parcel requested to be delivered in response to a request from a client who requests delivery of the parcel; and
a selecting unit that selects, on a basis of the information regarding the external shape of the parcel, which is received by the receiving unit, a delivery apparatus that delivers the parcel by taking into consideration empty space in the delivery apparatus.

2. The parcel delivery system according to claim 1, wherein the information regarding the external shape of the parcel is information obtained from a captured image of the external shape of the parcel.

3. The parcel delivery system according to claim 2, wherein the information regarding the external shape of the parcel is information on an external size of the parcel, which is obtained by identifying coordinates of the parcel in three-dimensional space from the captured image.

4. The parcel delivery system according to claim 1, wherein the empty space in the delivery apparatus is grasped from a captured image of the empty space that is obtained by an image capturing unit installed in the delivery apparatus.

5. The parcel delivery system according to claim 4, wherein a size of the empty space is grasped by identifying coordinates of the empty space in three-dimensional space from the captured image.

6. The parcel delivery system according to claim 1, wherein the selecting unit selects a delivery apparatus that has empty space capable of accommodating the parcel as a delivery apparatus that delivers the parcel.

7. The parcel delivery system according to claim 6, wherein the selecting unit selects a delivery apparatus that delivers the parcel further on a basis of a weight of the parcel.

8. The parcel delivery system according to claim 7, wherein the selecting unit selects a delivery apparatus capable of accommodating the parcel on a basis of the weight of the parcel and a deliverable weight of a delivery apparatus that is grasped by measurement done by a weight measurement unit installed in the delivery apparatus.

9. A parcel delivery system comprising:
a receiving unit that receives information regarding an external shape of a parcel requested to be delivered in response to a request from a client who requests delivery of the parcel; and
a notifying unit that notifies the client of information indicating a state in which the parcel is not accommodable in space in a delivery apparatus in a case where the parcel is not accommodable in the space on a basis of the information regarding the external shape of the parcel that is received by the receiving unit.

10. A non-transitory computer readable medium storing a program causing a computer operated by a client who requests delivery of a parcel to function as:
an estimating unit that estimates an external size of the parcel from a captured image of an external shape of the parcel; and
a requesting unit that requests delivery by a delivery apparatus capable of accommodating the parcel having an estimated size.

11. The non-transitory computer readable medium according to claim 10, wherein the estimating unit estimates the external size of the parcel on a basis of reference points designated by the client in the captured image in order to estimate the external size of the parcel.

12. The non-transitory computer readable medium according to claim 10, the program further causing the computer to function as:
an obtaining unit that obtains information regarding a weight of the parcel,
wherein the requesting unit additionally outputs the information regarding the weight of the parcel.

13. The non-transitory computer readable medium according to claim 12, wherein the information regarding the weight of the parcel includes at least one of a captured image of contents of the parcel and a weight estimated from the captured image.

14. The non-transitory computer readable medium according to claim 13, wherein:
the computer includes a display screen, and
the program further causes the computer to display, on the display screen, the weight estimated from the captured image of the contents of the parcel.

15. The non-transitory computer readable medium according to claim 13, wherein:
the computer includes a display screen, and
the program further causes the computer to display, on the display screen, information on a comparison target having a weight equivalent to the weight estimated from the captured image of the contents of the parcel.

16. The non-transitory computer readable medium according to claim 10, wherein:
the computer includes a display screen, and
the program further causes the computer to display, in a case where the parcel requested to be delivered is not accommodable in empty space in a delivery apparatus, the empty space in the delivery apparatus and the external shape of the parcel one above the other on the display screen.

17. The non-transitory computer readable medium according to claim 16, the program further causing the computer to display, on the display screen, a length of the parcel that exceeds the empty space in the delivery apparatus.

18. A non-transitory computer readable medium storing a program causing a computer to realize:
a function of receiving information regarding an external shape of a parcel requested to be delivered in response to a request from a client who requests delivery of the parcel; and
a function of notifying the client of information indicating a state in which the parcel is not accommodable in space in a delivery apparatus in a case where the parcel is not accommodable in the space on a basis of the received information regarding the external shape of the parcel.
